(19) United States
(12) Patent Application Publication
(10) Pub. No.: US 2008/0040196 A1
(43) Pub. Date: Feb. 14, 2008

(54) Method, system and program product for hosting an on-demand customer interaction center utility infrastructure

(75) Inventors: Robert E. Coon, Port Orange, FL (US); James M. Donnelly, Alpharetta, GA (US); Michael S. Matthews, Roswell, GA (US); Vanessa V. Michelini, Boca Raton, FL (US)

Correspondence Address: SILVY ANNA MURPHY, 100 TURNBERRY LANE, CARY, NC, 27518, US

(73) Assignee: International Business Machines Corporation, Armonk, NY (US)

(21) Appl. No.: 11/482,254

(22) Filed: Jul. 6, 2006

(51) Int. Cl. G07G 1/00

(52) U.S. Cl. 705/10

(57) ABSTRACT

A method, system and program product for hosting an on-demand customer interaction contact center utility infrastructure is provided. The method includes negotiating competitive prices with a plurality of vendors for each of the plurality of components of the on-demand customer interaction center utility infrastructure. Further, the method includes providing an on-demand customer interaction center utility infrastructure serving a plurality of customers and including a plurality of components. The method includes configuring a solution for a customer, the solution including sharing one or more components of the plurality of components of the on-demand customer interaction center utility infrastructure and establishing metrics to be monitored and achieved for the customer for calculating a customer utilization fee, such that the customer pays for the one or more components utilized in the on-demand customer interaction center utility infrastructure based on achievement of the metrics established and monitored.

### FIELD OF THE INVENTION

The present invention relates to the field of contact centers and, more particularly, the invention relates to a method, system and computer program product for hosting an on-demand customer interaction center utility infrastructure for serving multiple customers.

### BACKGROUND OF THE INVENTION

In today's business environment, organizations and/or businesses utilize call centers to interact with their customers. Management of call centers involves balancing cost effectiveness and service. Often, organizations have to invest a lot of money to establish a call center infrastructure, while maintaining high levels of customer service. As such, there is a need for an efficient way to provide satisfactory service to the customers of these organizations, while maintaining costs associated with operating a call center.

### SUMMARY OF THE INVENTION

In a first aspect of the invention, there is provided a method for implementing an on-demand customer interaction center utility infrastructure serving a plurality of customers in a shared environment. The method comprises providing an on-demand customer interaction center utility infrastructure serving a plurality of customers, the on-demand customer interaction center utility infrastructure comprises a plurality of components, configuring a solution for at least one customer of the plurality of customers, the solution comprises sharing one or more components of the plurality of components of the on-demand customer interaction center utility infrastructure and establishing metrics to be monitored and achieved for the at least one customer for calculating a customer utilization fee, such that the at least one customer pays for the one or more components utilized in the on-demand customer interaction center utility infrastructure based on achievement of the metrics. In an embodiment, the providing step further comprises negotiating competitive prices with a plurality of vendors for each of the plurality of components of the on-demand customer interaction center utility infrastructure. In another embodiment, the providing step further comprises providing a production environment comprising a separate location for ensuring business continuity of the at least one customer and providing a development and testing environment for developing and testing a modification to the plurality of components of the on-demand customer interaction center utility infrastructure before deployment in the production environment. In an embodiment, the one or more components comprises at least one of: infrastructure component, processes and applications component, contact center operations and management component, reporting component, and human resources component. In an embodiment, the infrastructure component comprises at least one of: computer resources, network resources, security resources and software resources. In an embodiment, the contact center operations and management component comprises at least one of work force management, quality assurance monitoring and knowledge database. In an embodiment, the reporting component comprises at least one of: usage metrics and utilization, agent performance, and end-to-end customer interaction. In an embodiment, the human resources component comprises at least one of: development personnel, maintenance personnel, support personnel, vendor management personnel and project management personnel.

In another aspect of the invention, there is provided a system for hosting an on-demand customer interaction center utility infrastructure. The system comprises a network communications channel, one or more call centers connected via the network communications channel, an on-demand customer interaction center utility infrastructure coupled to the one or more call centers via the network communications channel, the on-demand customer interaction center utility infrastructure comprises a plurality of components configured to serve a plurality of customers, including a component for tracking usage metrics to be achieved for one or more components selected to be shared and utilized by each customer of the plurality of customers, and wherein the one or more components selected is configured to provide a comprehensive solution for service delivery to end users of each customer of the plurality of customers, such that an end user of any customer of the plurality of customers can access the service delivery provided by the on-demand customer interaction center utility infrastructure on behalf of any customer using any one of multiple channels supported by the network communications channel, and such that each customer pays for the one or more components utilized based on achievement of the usage metrics tracked and achieved, wherein the on-demand customer interaction center utility infrastructure provides a production environment comprising a separate location for ensuring business continuity of the at least one customer and provides a development and testing environment for developing and testing a modification to the plurality of components of the on-demand customer interaction center utility infrastructure before deployment in the production environment.

In an embodiment, the one or more components comprises at least one of: infrastructure component, processes and applications component, contact center operations and management component, reporting component, and human resources component. In an embodiment, the infrastructure component comprises at least one of: computer resources, network resources, security resources and software resources. In an embodiment, the contact center operations and management component comprises at least one of work force management, quality assurance monitoring and knowledge database. In an embodiment, the reporting component comprises at least one of: usage metrics and utilization, agent performance, and end-to-end customer interaction. In an embodiment, the human resources component comprises at least one of: development personnel, maintenance personnel, support personnel, vendor management personnel and project management personnel.

In yet another aspect of the invention, there is provided a computer program product for implementing an on-demand customer interaction center utility infrastructure serving a plurality of customers in a shared environment. The computer program product comprises a computer readable medium, first program instructions to establish an on-demand customer interaction center utility infrastructure for delivering services to end users of a plurality of customers, the on-demand customer interaction center utility infrastructure comprising a plurality of components. The computer program product further comprises second program instructions to customize a comprehensive solution for at least one customer of the plurality of customers involving configuring one or more components selected from the on-demand customer interaction center utility infrastructure to be shared and utilized by the at least one customer with the plurality of customers, third program instructions to determine metrics to be measured and achieved for the at least one customer for calculating a customer utilization fee based on the one or more components shared and utilized by the at least one customer and based on the metrics measured and achieved for the at least one customer. Preferably, the first, second and third program instructions are stored on the computer readable medium. In an embodiment, the first program instructions include instructions to provide a production environment comprising a separate location for ensuring business continuity of the at least one customer of the plurality of customers and to provide a development and testing environment for developing and testing a modification to the plurality of components of the on-demand customer interaction center utility infrastructure before deployment in the production environment. In an embodiment, the one or more components comprises at least one of: infrastructure component, processes and applications component, contact center operations and management component, reporting component, and human resources component. In an embodiment, the infrastructure component comprises at least one of: computer resources, network resources, security resources and software resources. In an embodiment, the contact center operations and management component comprises at least one of work force management, quality assurance monitoring and knowledge database. In an embodiment, the reporting component comprises at least one of: usage metrics and utilization, agent performance, and end-to-end customer interaction and wherein the human resources component comprises at least one of: development personnel, maintenance personnel, support personnel, vendor management personnel and project management personnel.

Further, in yet another aspect of the invention, there is provided a process for deploying computing infrastructure comprises integrating computer-readable code into a computing system, wherein the code in combination with the computing system is capable of performing a process for hosting an on-demand customer interaction center utility infrastructure. The process comprises providing an on-demand customer interaction center utility infrastructure serving a plurality of customers, the on-demand customer interaction center utility infrastructure comprising a plurality of components, configuring a solution for a customer of the plurality of customers, the solution comprising sharing one or more components of the plurality of components of the on-demand customer interaction center utility infrastructure and establishing metrics to be monitored and achieved for the customer for calculating a customer utilization fee, such that the customer pays for the one or more components utilized in the on-demand customer interaction center utility infrastructure based on achievement of the metrics. In an embodiment, the providing step further comprises negotiating competitive prices with a plurality of vendors for each of the plurality of components of the on-demand customer interaction center utility infrastructure. In an embodiment, the providing step further comprises providing a production environment comprises a separate location for ensuring business continuity of the customer and providing a development and testing environment for developing and testing a modification to the plurality of components of the on-demand customer interaction center utility infrastructure before deployment in the production environment. In an embodiment, the one or more components comprises at least one of: infrastructure component, processes and applications component, contact center operations and management component, reporting component, and human resources component. In an embodiment, the infrastructure component comprises at least one of: computer resources, network resources, security resources and software resources. In an embodiment, the contact center operations and management component comprises at least one of work force management, quality assurance monitoring and knowledge database. In an embodiment, the reporting component comprises at least one of: usage metrics and utilization, agent performance, and end-to-end customer interaction. In an embodiment, the human resources component comprises at least one of: development personnel, maintenance personnel, support personnel, vendor management personnel and project management personnel.

### BRIEF DESCRIPTION OF THE DRAWINGS

The accompanying drawings, which are incorporated in and form a part of this specification, illustrate embodiments of the invention and, together with the description, serve to explain the principles of the invention:

FIG. 1 is a flowchart depicting a method of implementing an on-demand customer interaction center utility infrastructure serving multiple customers, in accordance with an embodiment of the present invention.

FIG. 2 is a schematic block system diagram illustrating an on-demand customer interaction center utility infrastructure that includes multiple components for serving multiple customers, in accordance with an embodiment of the present invention.

FIG. 3 is a schematic block system diagram illustrating an on-demand customer interaction center utility infrastructure that includes multiple components and sub-components for serving multiple customers, in accordance with an embodiment of the present invention.

FIG. 4 is an illustration of an on-demand customer interaction center utility infrastructure showing the telephony, operations and business layers each having multiple components for serving multiple customers, in accordance with an embodiment of the present invention.

FIG. 5 is an illustration of an on-demand customer interaction center utility infrastructure showing the multiple components that may be shared by multiple customers, in accordance with an embodiment of the present invention.

FIG. 6 is an illustration of an on-demand customer interaction center utility infrastructure that includes a production environment and a development and testing environment at one site and a duplicate production environment at a second site, in accordance with an embodiment of the present invention.

### BEST MODE FOR CARRYING OUT THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Moreover, the described features, structures, or characteristics of the invention may be combined in any suitable manner in one or more embodiments. It will be apparent to those skilled in the art that various modifications and variations can be made to the present invention without departing from the spirit and scope of the invention. Thus, it is intended that the present invention cover the modifications and variations of this invention provided they come within the scope of the appended claims and their equivalents. Reference will now be made in detail to the preferred embodiments of the invention.

In one embodiment, the present invention provides a method for implementing an on-demand customer interaction center utility infrastructure serving a plurality of customers in a shared environment. The method comprises providing an on-demand customer interaction center utility infrastructure serving a plurality of customers, the on-demand customer interaction center utility infrastructure comprises a plurality of components, configuring a solution for at least a customer of the plurality of customers, the solution comprises sharing one or more components of the plurality of components of the on-demand customer interaction center utility infrastructure and establishing metrics to be monitored and achieved for the at least one customer for calculating a customer utilization fee, such that the at least one customer pays for the one or more components utilized in the on-demand customer interaction center utility infrastructure based on achievement of the metrics established and monitored. In an embodiment, the providing step further comprises negotiating competitive prices with a plurality of vendors for each of the plurality of components of the on-demand customer interaction center utility infrastructure. In another embodiment, the providing step further comprises providing a production environment comprises a separate location for ensuring business continuity of the at least one customer and providing a development and testing environment for developing and testing a modification to the plurality of components of the on-demand customer interaction center utility infrastructure before deployment in the production environment. In an embodiment, the one or more components comprises at least one of: infrastructure component, processes and applications component, contact center operations and management component, reporting component, and human resources component. In an embodiment,.the infrastructure component comprises at least one of: computer resources, network resources, security resources and software resources. In an embodiment, the contact center operations and management component comprises at least one of work force management, quality assurance monitoring and knowledge database. In an embodiment, the reporting component comprises at least one of: usage metrics and utilization, agent performance, and end-to-end customer interaction. In an embodiment, the human resources component comprises at least one of: development personnel, maintenance personnel, support personnel, vendor management personnel and project management personnel.

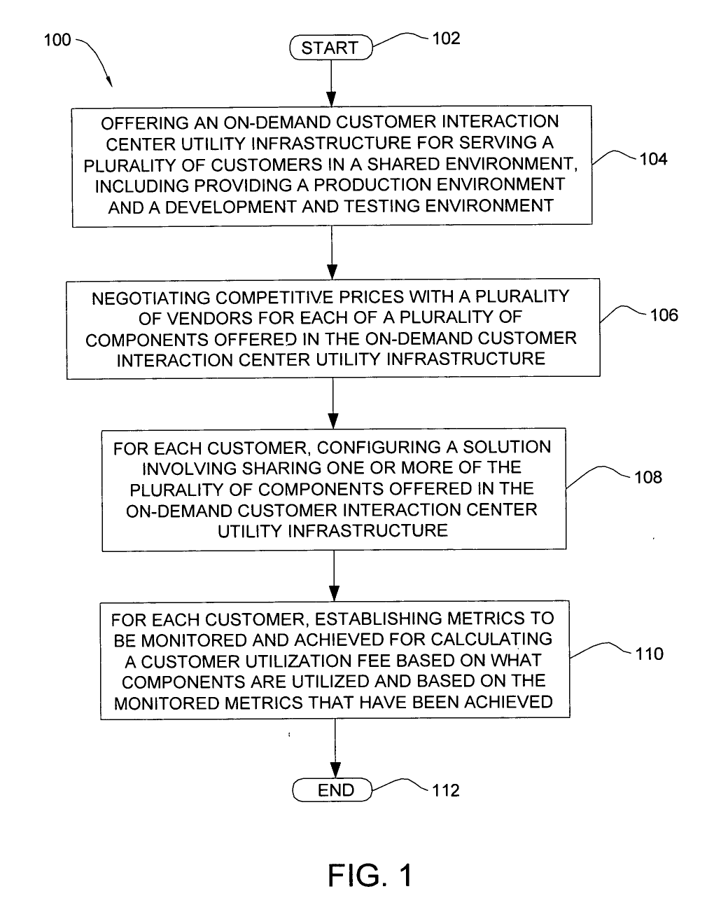

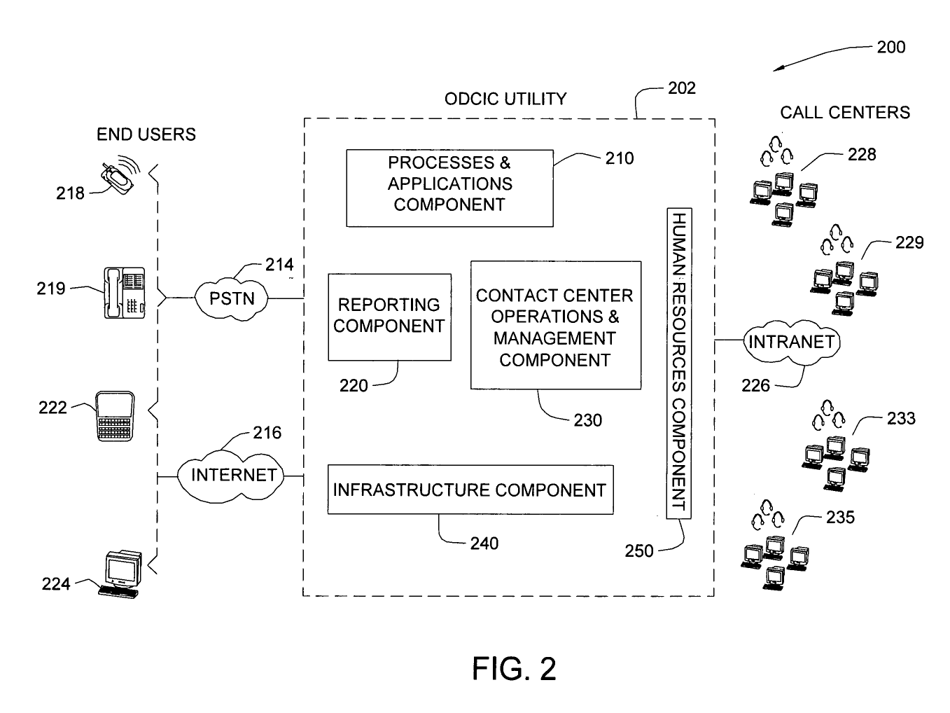

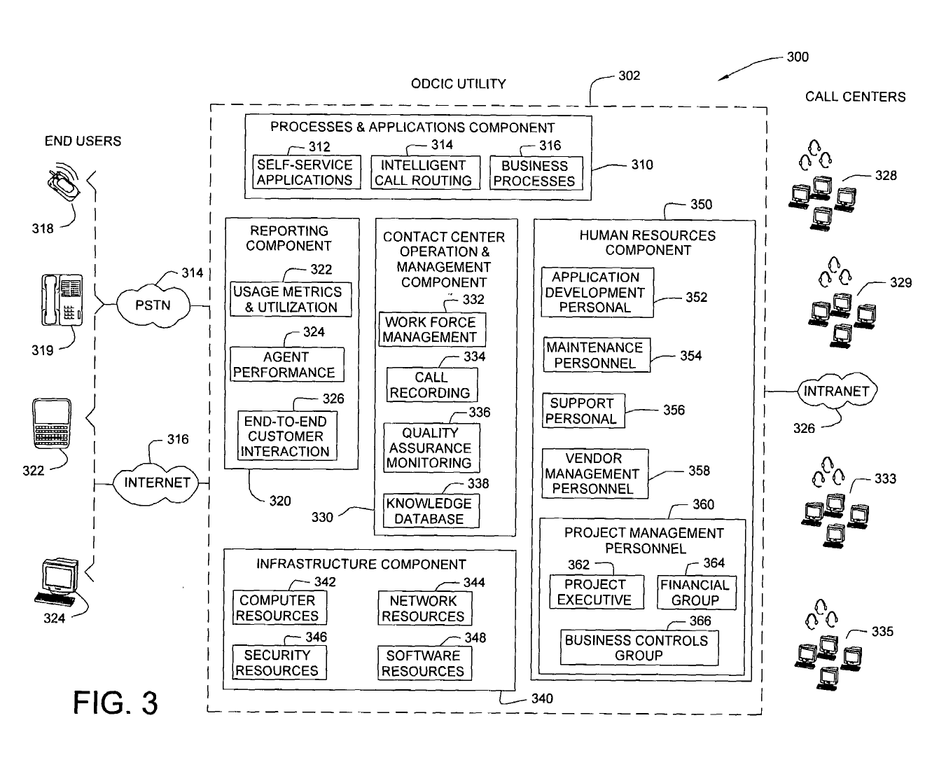

Reference is now made to FIG. 1, which illustrates a method for implementing an on-demand customer interaction center utility (ODCIC) infrastructure serving multiple customers, in accordance with an embodiment of the invention. The method 100 starts at step 102 with a hosting company or service provider offering or providing in step 104 an on-demand customer interaction center utility infrastructure that is configured to serve a plurality of customers in a shared environment. In an embodiment, the on-demand customer interaction center utility infrastructure includes a plurality of components, as will be discussed herein below with respect to FIGS. 2 and 3. The hosting company or service provider negotiates in step 106 competitive prices with a plurality of vendors for each of the plurality of components in the on-demand customer interaction center utility infrastructure. Further, in step 108, the hosting company or service provider configures a solution for each customer of the plurality of customers that involves sharing one or more of the plurality of components offered in the on-demand customer interaction center utility infrastructure. Preferably, the plurality of customers includes 1 through N customers, with N being a whole integer. Moreover, for each customer, in step 110, the hosting company or service provider establishes metrics that are to be monitored and achieved for calculating a customer utilization fee based on what components are utilized and based on the monitored metrics that have been achieved, ending in step 112. In particular, the plurality of customers may include at least a first customer with a first set of established metrics, a second customer with a second set of established metrics, etc. As such, the hosting company or service provider tracks the components of the on-demand customer interaction center utility infrastructure that are utilized by a particular customer among the plurality of customers, so that the customer only pays for the components utilized. Further, the hosting company or service provider tracks whether or not the metrics that have been monitored for a particular customer have been achieved, such that the customer only pays for the utilization of the components based on the metrics that have been achieved.

For instance, if a customer wants to switch from using their current call center to using an on-demand customer interaction center (ODCIC) utility infrastructure offered by a hosting company or service provider in order to reduce costs, the customer would enter into negotiations with the hosting company or service provider to obtain the appropriate services offered by the on-demand customer interaction center utility infrastructure. In particular, in order to configure a solution for the customer, the hosting company or service provider would take an inventory of the customer's existing call center operations, including the various hardware and software resources currently being used, the various call center management tools being used as well as the number of users, agents, etc. in order to understand the business of the customer and to understand the role played by the call center for the customer. Further, the hosting company or service provider would determine based on the information gathered from the customer's existing operations which of the components of the on-demand customer interaction center utility infrastructure could be shared by the customer with other customers. For instance, there are functions that are common to many call centers. Thus, if there are two customers using the on-demand customer interaction center utility infrastructure for their call centers, the hosting company or service provider is able to configure standardized solutions for both customers that involves sharing some of the components in the on-demand customer interaction center utility infrastructure that are necessary for achieving these common functions. Additionally, there are security measures (firewalls, etc.) that are put in place within the on-demand customer interaction center utility infrastructure, so that one customer's information is not divulged to another customer. Accordingly, the standardization of a customer solution reduces technical risks, shortens the proposal timeframe and minimizes the testing of solutions, since such solutions have already been tested for one or more of the other customers. Further, the standardization reduces costs to the customer, for instance, machine capacity is optimized given that more than one customer is utilizing the capacity of a machine and/or resource. Further, given that more resources (equipment and personnel) are available to a customer increases overall customer satisfaction. As such, the shared environment provided by the on-demand customer interaction center utility infrastructure ensures that the utilization of all resources, be it hardware, software and/or human resources is optimized. Moreover, the hosting company or service provider establishes one or more metrics that are to be tracked for each customer, especially for the purpose of paying for the various components in the on-demand customer interaction center utility infrastructure that are being utilized by the customer. For instance, some metrics that may be tracked are the number of first call resolution (FCR) calls, where the customer makes a call to the service provider and the provider solves the problem(s) raised during that call, such that if the customer has to call again for the same problem(s) raised in the previous call, the first call is not counted as a FCR; average handle time (AHT), that is the amount of time it takes an agent to complete a call made up of one or more customer requests, including talk time, and hold time, etc.; customer satisfaction, which is generally measured by surveys conducted using, for instance, a customer survey module provided in a quality assurance tool; and number of calls completed in the IVR (that is, automated calls where no human intervention occurs), so that labor costs can be reduced. Other factors that affect the metrics tracked are hold time, design of the IVR application(s) (IVR applications are designed typically as press 1 for x, press 2 for y, or use speech recognition such as “what is your zip code?”, etc., thus, the IVR design is monitored to see how easily a customer can navigate within the IVR), number of abandoned calls, an agent's politeness, etc. Thus, various metrics can be combined to create contractual service level agreements, where the service provider may have to pay penalties if certain metrics have not been met, such as, any established metrics for a combination of calls completed within the IVR and customer satisfaction ratings. If the IVR application is designed poorly, customers may be retained within the IVR and calls may be completed, but customer satisfaction may decrease, so a combined metric can balance these two measurements. Further, in an on-demand customer interaction center utility infrastructure environment, the service provider can prepare to handle seasonal call volume peaks or a marketing campaign that drives call volume up, for instance, by charging for such peaks without having to charge for the whole environment all the time, when the utilization is normal. Additionally, the on-demand customer interaction center utility infrastructure provides both a production environment for a customer and a development and testing environment, where changes can be tested before implementing the changes in the production environment, thus, minimizing downtime of the on-demand customer interaction center utility infrastructure. Furthermore, the on-demand customer interaction center utility infrastructure provides a separate backup site for disaster recovery capability, so that if the main site gets wiped out, the backup site can take over operations until the main site is back up and running.

Accordingly, a hosting company or service provider offering the on-demand customer interaction center utility infrastructure can provide an outsourcing company with a competitive advantage. One advantage of the on-demand customer interaction center utility infrastructure is the usage of economies of scale to get competitive prices from third party vendors, so that the overall solution that is configured for a particular customer is cost efficient. Since the hosting company or service provider is offering the on-demand customer interaction center utility infrastructure to multiple customers, the hosting company or service provider is able to leverage the large customer base in negotiations with vendors that are competing against each other. Another advantage of the on-demand customer interaction center utility infrastructure is the optimal utilization of resources, thus, reducing costs to the customer. Further, yet another advantage of the on-demand customer interaction center utility infrastructure is the provision to customers of paying only for components that are utilized and based on certain metrics or terms that have been established at the onset for the customer.

In another embodiment of the invention, there is provided a system for hosting an on-demand customer interaction center utility infrastructure. The system comprises a network communications channel, one or more call centers connected via the network communications channel, an on-demand customer interaction center utility infrastructure coupled to the one or more call centers via the network communications channel, the on-demand customer interaction center utility infrastructure comprises a plurality of components configured to serve a plurality of customers, including a component for tracking usage metrics to be achieved for one or more components selected to be shared and utilized by each customer of the plurality of customers, wherein the one or more components selected is configured to provide a comprehensive solution for service delivery to end users of each customer of the plurality of customers, such that an end user of any customer of the plurality of customers can access the service delivery provided by the on-demand customer interaction center utility infrastructure on behalf of any customer using any one of multiple channels supported by the network communications channel, and such that each customer pays for the one or more components utilized based on achievement of the usage metrics tracked and achieved, wherein the on-demand customer interaction center utility infrastructure provides a production environment comprising a separate location for ensuring business continuity of the at least one customer and provides a development and testing environment for developing and testing a modification to the plurality of components of the on-demand customer interaction center utility infrastructure before deployment in the production environment. In an embodiment, the one or more components comprises at least one of: infrastructure component, processes and applications component, contact center operations and management component, reporting component, and human resources component. In an embodiment, the infrastructure component comprises at least one of: computer resources, network resources, security resources and software resources. In an embodiment, the contact center operations and management component comprises at least one of work force management, quality assurance monitoring and knowledge database. In an embodiment, the reporting component comprises at least one of: usage metrics and utilization, agent performance, and end-to-end customer interaction. In an embodiment, the human resources component comprises at least one of: development personnel, maintenance personnel, support personnel, vendor management personnel and project management personnel.

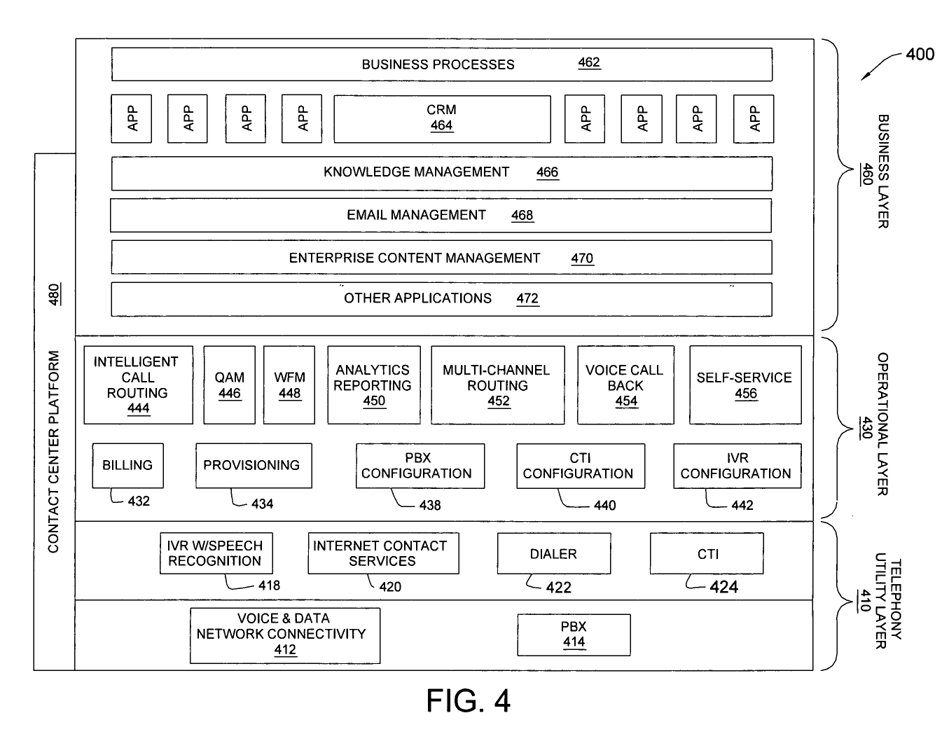

Reference is now made to FIGS. 2 through 4, which illustrate an embodiment of the on-demand customer interaction center utility infrastructure. Turning to FIG. 2, reference numeral 200 shows a schematic block system diagram that illustrates an on-demand customer interaction center utility infrastructure that includes multiple components for serving multiple customers, in accordance with an embodiment of the invention. As shown in FIG. 2, the on-demand customer interaction center utility infrastructure 202 includes multiple components, which together provide a tool set for the hosting company or service provider that can be used to provide services to multiple customers. In an embodiment, the on-demand customer interaction center utility infrastructure 202 includes an infrastructure component 240, a reporting component 220, a contact center operations and management component 230, a process and applications component 210, and a human resources component 250. Each of the components of the on-demand customer interaction center utility infrastructure 202 will be discussed further herein below with respect to FIGS. 3 and 4. Further, as shown in FIG. 2, end users who use the services provided by the on-demand customer interaction center utility infrastructure 202 are able to interact with the on-demand customer interaction center utility infrastructure 202 using various devices, such as, a cell phone 218, or a telephone 219 that connects via a public switched telephone network (PSTN) 214 to the on-demand customer interaction center utility infrastructure 202. Similarly, end users may obtain services provided by the on-demand customer interaction center utility infrastructure 202 via the Internet 216 by using a blackberry device 222 or a desktop or laptop 224. Moreover, as shown in FIG. 2, the call centers 228, 229, 233 and 235 are where the calls come through the infrastructure 202, for instance, via the Intranet 226 and get routed to where the agents who interact with the customers are situated, which may be anywhere in the world.

Turning to FIG. 3, reference numeral 300 shows a schematic block system diagram that illustrates an on-demand customer interaction center utility infrastructure that includes multiple components and sub-components for serving multiple customers, in accordance with an embodiment of the invention. The on-demand customer interaction center utility infrastructure 302 includes multiple components, which together provide a tool set for a hosting company or service provider that can be used to provide services to multiple customers. In an embodiment, the on-demand customer interaction center utility infrastructure 302 includes an infrastructure component 340, a reporting component 320, a contact center operations and management component 330, a process and applications component 310, and a human resources component 350. As shown in an embodiment in FIG. 3, the infrastructure component 340 further includes sub-components for carrying out various functions within the on-demand customer interaction center utility infrastructure 302. In an embodiment, the infrastructure component 340 includes computer resources 342, network resources 344, security resources 346 and software resources 348. In an embodiment, the contact center operations and management component 330 includes sub-components, such as, work force management 332, call recording 334, quality assurance monitoring 336, and knowledge database 338. In one embodiment, the reporting component 320 includes sub-components, such as, usage metrics and utilization 322, agent performance 324, and end-to-end customer interaction 326. Additionally, the processes and applications component 310 comprises sub-components, such as, self-service applications 312, intelligent call routing applications 314 and business processes 316. Further, the human resources component 350 includes sub-components, such as, application development personnel 352, maintenance personnel 354, support personnel 356, vendor management personnel 358 and project management personnel 360. In an embodiment, the project management personnel 360 further includes project executive group 362, financial group 364, and business controls group 366. Further, as shown in FIG. 3, end users who use the services provided by the on-demand customer interaction center utility infrastructure 302 are able to interact with the on-demand customer interaction center utility infrastructure 302 using various devices, such as, a cell phone 318, or a telephone 319 that connects via a public switched telephone network (PSTN) 314 to the on-demand customer interaction center utility infrastructure 302. Similarly, end users may obtain services provided by the on-demand customer interaction center utility infrastructure 302 via the Internet 316 by using a blackberry device 322 or a desktop or laptop 324. Moreover, as shown in FIG. 3, the call centers 328, 329, 333 and 335 are where the calls come through the infrastructure 302, for instance, via the Intranet 326 and get routed to where the agents who interact with the customers are situated, which may be anywhere in the world. Although, each component in FIG. 3 is depicted as have the sub-components described therein, it will be apparent to one skilled in the art that other components and/or sub-components can be included or substituted as suited for a give business or organization.

Turning to FIG. 4, reference numeral 400 depicts an on-demand customer interaction center utility infrastructure showing the telephony, operations and business layers with each having multiple components for serving multiple customers, in accordance with an embodiment of the invention. As shown in FIG. 4, the on-demand customer interaction center utility infrastructure 400 includes a contact center platform 480 that supports a telephony utility layer 410, an operational layer 430 and a business layer 460. In an embodiment, the telephony utility layer 410 includes resources (hardware, software and personnel) for interactive voice recognition (IVR) with speech recognition 418, Internet contact services 420, dialer 422, computer telephony integration (CTI) 424, voice and data network connectivity 412 and private branch exchange (PBX) 414. The IVR (interactive voice response) system 418 provides a front-end interface used to automate simple tasks without human intervention and/or to capture information before transferring a caller to an agent. Further, a speech recognition and text-to-speech feature is used in conjunction with the IVR system 418 in order to provide speech recognition capabilities for more natural human-computer interaction. The Internet contact services system 420 provides web self service applications. A dialer system 422 or predictive dialer system is programmed to make calls and is typically used in marketing and sales. The CTI system 424 allows the agents to readily identify most of the customers who are calling and eliminates the need for the agents to ask the customer for phone numbers, account information, or other identifying data. This improves customer satisfaction as well as leads to the reduction of agent average handle time per call. The CTI system 424 provides the capability of passing any data collected in the IVR system 418 and other systems to agents, for instance via a screen pop where relevant information pops up on an agent desktop monitor. The voice and data network connectivity system 412 handles the transport of voice and data. Further, the PBX system 414 receives and automatically distributes calls for agents to handle.

Further, the operational layer 430 includes resources (hardware, software and personnel) for common functions performed by a contact center, such as, intelligent call routing 444, quality assurance monitoring (QAM) 446, work force management (WFM) 448, analytics reporting 450, multi-channel routing 452, voice call back 454, self-service 456. An intelligent call routing system 444 provides rules that define how to transfer a call. The rules can be based on several factors, for instance, skills (language, technical, area, etc), holidays, business hours, agent availability (which agent is available next), etc. The quality assurance management (QAM) system 446 records agent/customer voice calls as well as agent desktop screens to monitor the agent's interaction with the customers. Supervisors and managers can analyze the agent interactions and through coaching or more formal training of agents' skills can improve and contribute to better customer satisfaction, average handle times for each customer call, and can provide an increase in first call resolution. The work force management (WFM) system 448 provides features for managing the agent schedules and the availability of agents to handle customer calls. These features are key to the overall integration with the intelligent call routing system 444 since customer calls get routed based on the number of agents available at a given call center. With percentage allocation versus intelligent call routing, calls are routed to call centers without knowing the availability of agents to handle these calls. As such, call centers can get “saturated” with calls, causing long hold times in queue for customers, leading to dissatisfied customers and/or abandoned calls. Hence, the full integration of a WFM system 448 with an intelligent call routing system 444 can reduce the number of abandoned calls. An analytics reporting system 450 provides a reporting of a call level view of a customer interaction with a call or contact center. A multi-channel routing system 452 provides the ability to support several “channels”, such as phone (voice), web, e-mail, fax, white mail, voice mail, etc. A voice call back system 454 is a voice mail system where a caller can leave a message for an agent to call back. A self-service system 456 is a combination of voice an web self-services applications that allow a user to complete a task with agent intervention, either using the IVR or web applications. Moreover, the operational layer 430 includes other functions that are tailored for each customer, such as, billing 432, provisioning 434 (enables the provisioning of information in the platform, such as, agent identifications, authority levels, etc.), PBX configuration 438, CTI configuration 440 and IVR configuration 442. Additionally, the business layer 460 of the on-demand customer interaction center utility infrastructure 400 includes resources (hardware, software and personnel) for business processes 462, for customer relationship management (CRM) 464, knowledge management 466, e-mail management 468, enterprise content management 470 and any other call/contact center applications 472. A knowledge management system 466 integrates, consolidates and filters data from multiple disparate sources. It combines that data with the goals of the center and the objectives and targets set for employees to deliver meaningful performance metrics and measurements. Agents use the knowledge management system 466 to search for answers to the most common questions encountered or for guidance on the resolution of common problems encountered.

Further, in another embodiment of the invention, there is provided a computer program product for implementing an on-demand customer interaction center utility infrastructure serving a plurality of customers in a shared environment. The computer program product comprises a computer readable or computer-usable medium, which provides program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device. Preferably, the computer storage medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD. Further, preferably, network medium can comprise of transmission devices on a network, such as, cables, routers, switches and/or network adapter cards. Further, the computer program product comprises first program instructions to establish an on-demand customer interaction center utility infrastructure for delivering services to end users of a plurality of customers, the on-demand customer interaction center utility infrastructure comprising a plurality of components. The computer program product further comprises second program instructions to customize a comprehensive solution for at least one customer of the plurality of customers involving configuring one or more components selected from the on-demand customer interaction center utility infrastructure to be shared and utilized by the at least one customer with the plurality of customers, third program instructions to determine metrics to be measured and achieved for the at least one customer for calculating a customer utilization fee based on the one or more components shared and utilized by the at least one customer and based on the metrics measured and achieved for the at least one customer. Preferably, the first, second and third program instructions are stored on the computer readable medium. In an embodiment, the first program instructions include instructions to provide a production environment comprising a separate location for ensuring business continuity of the at least one customer of the plurality of customers and to provide a development and testing environment for developing and testing a modification to the plurality of components of the on-demand customer interaction center utility infrastructure before deployment in the production environment. In an embodiment, the one or more components comprises at least one of: infrastructure component, processes and applications component, contact center operations and management component, reporting component, and human resources component. In an embodiment, the infrastructure component comprises at least one of: computer resources, network resources, security resources and software resources. In an embodiment, the contact center operations and management component comprises at least one of work force management, quality assurance monitoring and knowledge database. In an embodiment, the reporting component comprises at least one of: usage metrics and utilization, agent performance, and end-to-end customer interaction and wherein the human resources component comprises at least one of: development personnel, maintenance personnel, support personnel, vendor management personnel and project management personnel.

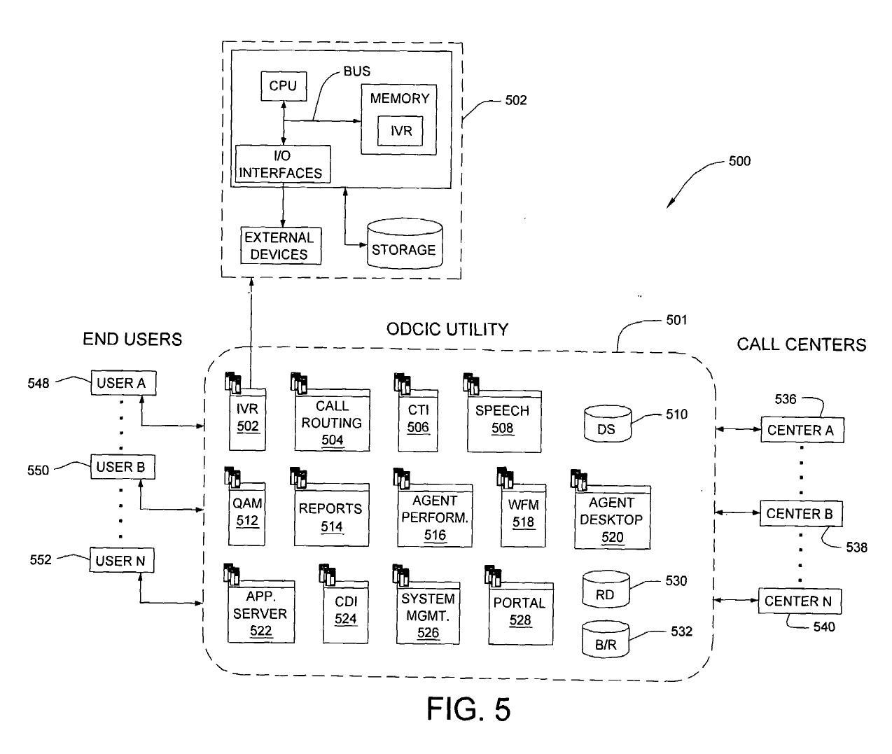

Turning to FIG. 5, reference numeral 500 depicts an on-demand customer interaction center utility infrastructure 501 showing the multiple components that may be shared by multiple customers, according to the invention. As depicted, system 500 includes an on-demand customer interaction center utility infrastructure 501, which is intended to represent any type of computer architecture that is maintained in a secure environment (i.e., for which access control is enforced). As shown in FIG. 5, the on-demand customer interaction center utility infrastructure 501 includes several computer systems (discussed further herein below), preferably, where each system typically represents a server or the like. It should be understood, however, that although not shown, other hardware and software components (e.g., additional computer systems, routers, firewalls, etc.) could be included in the on-demand customer interaction center utility infrastructure 501.

In general, any one of the end users A 548 or B 550 or C 552 may interface with the on-demand customer interaction center utility infrastructure 501 to obtain services provided by the on-demand customer interaction center utility infrastructure 501. Similarly, one or more contact centers A, B and C (designated by numerals 536, 538 and 540) can interface with the on-demand customer interaction center utility infrastructure 501. To this extent, the on-demand customer interaction center utility infrastructure 501 provides a secure environment. Although, FIG. 5 shows three end users 548, 550 and 552 and three call centers 536, 538 and 540, it is understood that the on-demand customer interaction center utility infrastructure 501 may be designed to handle multiple or a plurality of end users and multiple or a plurality of call centers. In general, the parties could access infrastructure 501 directly, or over a network via interfaces (e.g., web browsers) loaded on computerized devices (e.g., personal computers, laptops, handheld devices, etc., as shown in FIGS. 2 and 3). In the case of the latter, the network can be any type of network, such as the Internet, a local area network (LAN), a wide area network (WAN), a virtual private network (VPN), etc. In any event, communication with infrastructure 501 could occur via a direct hardwired connection (e.g., serial port), or via an addressable connection that may utilize any combination of wire line, such as, a public switched telephone network (PSTN), and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, the parties could utilize an Internet service provider to establish connectivity to the on-demand customer interaction center utility infrastructure 501. It should be understood that under the present invention, the on-demand customer interaction center utility infrastructure 501 could be owned and/or operated by a party such as a hosting company or service provider or by an independent entity (not shown in FIG. 5). Regardless, use of the on-demand customer interaction center utility infrastructure 501 and the teachings described herein could be offered to the parties on a subscription or fee-basis. In either scenario, an administrator (not shown in FIG. 5) could support and configure the on-demand customer interaction center utility infrastructure 501.

As shown in FIG. 5, the on-demand customer interaction center utility infrastructure 501 comprises of several computer or computing systems or devices (e.g., a server cluster) that preferably communicate over a network to perform the various process steps of the invention. In particular, the on-demand customer interaction center utility infrastructure 501 is shown to include a computer system 502 for performing IVR, a computer system 504 for intelligent call routing, a computer system 506 for CTI, a computer system 508 for speech, a computer system 512 for QAM, a computer system 514 for reports, a computer system 516 for agent performance (Agent Perform.), a computer system 518 for WFM, a computer system 520 for agent desktop, a computer system 522 configured to serve as an application server (App. Server), a computer system 524 for customer database integration (CDI), a computer system 526 for system management (System Mgmt) and a computer system 528 configured as a portal server. Further, the on-demand customer interaction center utility infrastructure 501 includes a database for directory services (DS) 510, a reporting database (RD) 530 and a backup/restore (B/R) database 532. In an embodiment, each of the computer systems 502, 504, 506, 508, 512, 514, 516, 518, 520, 522, 524, 526 and 528 includes a central processing unit (CPU), a memory, a bus, and input/output (I/O) interfaces, as shown only for computing system 502 in FIG. 5. However, each of the other computing systems 504, 506, 508, 512, 514, 516, 518, 520, 522, 524, 526 and 528, preferably, has a similar structure to that shown for computer system 502. Further, each of the computer systems may communicate with external I/O devices/resources, such as directory service (DS) 510 and/or storage systems 530 (reporting database) and/or 532 (backup/restore database).

The storage system of each of the computing systems 502, 504, 506, 508, 512, 514, 516, 518, 520, 522, 524, 526 and 528 can be any type of system (e.g., a database) capable of providing storage for information under the present invention. To this extent, each storage system could include one or more storage devices, such as a magnetic disk drive or an optical disk drive. In another embodiment, one or more of the storage systems within on-demand customer interaction center utility infrastructure 501 includes data distributed across, for example, a local area network (LAN), wide area network (WAN) or a storage area network (SAN) (not shown in FIG. 5). In general, the CPU of each of the computing systems shown in FIG. 5 executes computer program code(s) or modules stored therein. For example, the CPU of computer system 502 is configured to execute one or more computer program codes for an IVR application, which may be stored in a memory and/or storage system of computer system 502. Similarly, the CPU of computer system 504 executes one or more computer program codes for a call routing application stored in computer system 504, whereas, the CPU of computer system 506 executes one or more computer program codes for a CTI application stored in computer system 506. Further, the CPU of computer system 508 executes one or more computer program codes for speech recognition stored in computer system 508, whereas, the CPU of computer system 512 executes one or more computer program codes for a quality assurance monitoring application stored in computer system 512. Additionally, the CPU of computer system 514 executes one or more computer program codes for a reporting application stored in computer system 514. Further, as shown in FIG. 5, the CPU of computer system 516 executes one or more computer program codes for an agent performance application stored in computer system 516, whereas, the CPU of computer system 518 executes one or more computer program codes for a work force management application stored in computer system 518. Similarly, the CPU of computer system 520 executes one or more computer program codes for an agent desktop stored in computer system 520, such that an agent can interact with a customer. Moreover, in an embodiment, the computer system 522 in the on-demand customer interaction center utility infrastructure 501 serves as an application server, where the CPU of computer system 522 executes one or more application server codes. Further, the CPU of computer system 524 executes one or more computer program codes for customer database integration, whereas, the CPU of computer system 526 executes one or more computer program codes for system management. Further yet, the CPU of computer system 528 executes one or more portal server program codes.

In each of the computer systems of the on-demand customer interaction center utility infrastructure 501, while executing computer program code(s), each of the respective CPUs can read and/or write data, to/from memory, storage system, and/or I/O interfaces. The bus for each computer system provides a communication link between each of the components in the given computer system. External devices can comprise any devices (e.g., keyboard, pointing device, display, etc.) that enable an end user to interact with a computer system within the infrastructure 501 and/or any devices (e.g., network card, modem, etc.) that enable the computer system to communicate with one or more other computing devices within the infrastructure 501 or external to the infrastructure 501. The on-demand customer interaction center utility infrastructure 501 is only illustrative of various types of computer infrastructures for implementing the invention.

Moreover, the configuration of the computer system 502 as shown in FIG. 5 is only representative of various possible computer systems that can include numerous combinations of hardware. To this extent, in other embodiments, computer system 502 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, CPU may comprise a single processing unit, or be distributed across one or more processing units in one or more locations, e.g., on a client and server. Similarly, memory and/or storage system can comprise any combination of various types of data storage and/or transmission media that reside at one or more physical locations. Further, I/O interfaces can comprise any system for exchanging information with one or more external devices. Still further, it is understood that one or more additional components (e.g., system software, math co-processing unit, cache memory, etc.) not shown in FIG. 5 can be included in the on-demand customer interaction center utility infrastructure 501.

Further, in yet another embodiment of the invention, there is provided a process for deploying computing infrastructure comprises integrating computer-readable code into a computing system, wherein the code in combination with the computing system is capable of performing a process for hosting an on-demand customer interaction center utility infrastructure. The process comprises providing an on-demand customer interaction center utility infrastructure serving a plurality of customers, the on-demand customer interaction center utility infrastructure comprising a plurality of components, configuring a solution for a customer of the plurality of customers, the solution comprising sharing one or more components of the plurality of components of the on-demand customer interaction center utility infrastructure and establishing metrics to be monitored and achieved for the customer for calculating a customer utilization fee, such that the customer pays for the one or more components utilized in the on-demand customer interaction center utility infrastructure based on achievement of the metrics. In an embodiment, the providing step further comprises negotiating competitive prices with a plurality of vendors for each of the plurality of components of the on-demand customer interaction center utility infrastructure. In an embodiment, the providing step further comprises providing a production environment comprises a separate location for ensuring business continuity of the customer and providing a development and testing environment for developing and testing a modification to the plurality of components of the on-demand customer interaction center utility infrastructure before deployment in the production environment. In an embodiment, the one or more components comprises at least one of: infrastructure component, processes and applications component, contact center operations and management component, reporting component, and human resources component. In an embodiment, the infrastructure component comprises at least one of: computer resources, network resources, security resources and software resources. In an embodiment, the contact center operations and management component comprises at least one of work force management, quality assurance monitoring and knowledge database. In an embodiment, the reporting component comprises at least one of: usage metrics and utilization, agent performance, and end-to-end customer interaction. In an embodiment, the human resources component comprises at least one of: development personnel, maintenance personnel, support personnel, vendor management personnel and project management personnel.

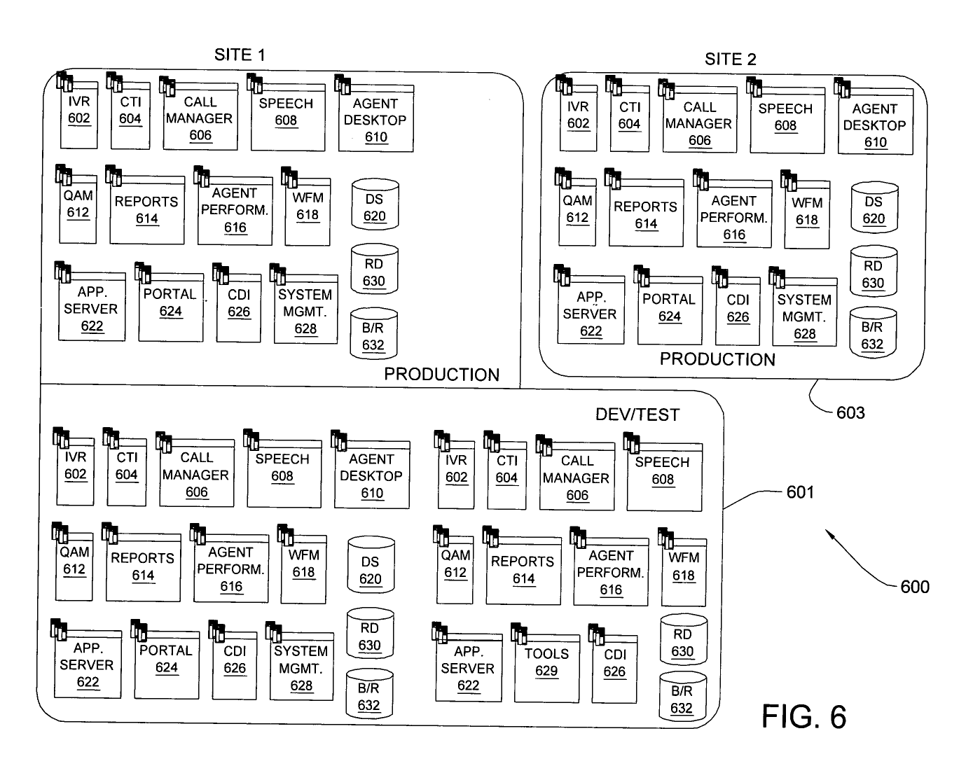

Reference is now made to FIG. 6, which illustrates an on-demand customer interaction center utility infrastructure 600 that includes a production environment and a development and testing environment at one site (site 1, referenced by reference numeral 601) and a duplicate or backup production environment at a second site (site 2, referenced by reference numeral 603), according to the present invention. The production environment of the on-demand customer interaction center utility infrastructure at 601 comprises of several computer or computing systems or devices (e.g., a server cluster) that preferably communicate over a network to perform the various process steps of the invention. In particular, the on-demand customer interaction center utility infrastructure 601 at site 1 is shown to include a computer system 602 for performing IVR, a computer system 604 for CTI, a computer system 606 for a call manager for intelligent call routing, a computer system 608 for speech, a computer system 610 for agent desktop, a computer system 612 for QAM, a computer system 614 for reports, a computer system 616 for agent performance, a computer system 618 for WFM, a computer system 622 configured to serve as an application server, a computer system 624 configured to serve as a portal server, a computer system 626 for customer database integration (CDI), and a computer system 628 for system management. Further, the on-demand customer interaction center utility infrastructure 601 includes a database 620 for directory services (DS), a reporting database 630 (RD) and a backup/restore (B/R) database 632.

Moreover, in an embodiment of the invention, the on-demand customer interaction center utility infrastructure includes a backup production environment 603 for disaster recovery capability, such that if the on-demand customer interaction center utility infrastructure 601 at site 1 gets wiped out, the on-demand customer interaction center utility infrastructure 603 at site 2 can take over operations until site 1 is back up and running. Accordingly, as shown in FIG. 6, the production environment of the on-demand customer interaction center utility infrastructure 601 at site 1 is duplicated at site 2 (reference numeral 603). As such, the production environment 603 at site 2 has an identical structure as that of site 1, as already described hereinabove with respect to infrastructure 601 and, thus, will not be repeated for the infrastructure 603 at site 2. Further, the on-demand customer interaction center utility infrastructure 601 at site 1 includes a development and testing environment, where any changes to the production environment can be developed and tested in the development and testing environment before implementing the changes within the production environment. In particular, the left half of the development and testing environment of the on-demand customer interaction center utility infrastructure 601 (lower half of infrastructure 601) includes all of the several computing systems or devices shown in the production environment (upper half of infrastructure 601) and, thus, are numbered the same for convenience. In particular, the development and testing environment at site 1 is shown to include a computer system 602 for performing. IVR, a computer system 604 for CTI, a computer system 606 for call manager functions, such as, intelligent call routing, a computer system 608 for speech, a computer system 610 for agent desktop, a computer system 612 for QAM, a computer system 614 for reports, a computer system 616 for agent performance, a computer system 618 for WFM, a computer system 622 configured to serve as an application server (App. Server), a computer system 624 configured to serve as a portal server, a computer system 626 for customer database integration (CDI), and a computer system 628 for system management (System Mgmt). Further, the on-demand customer interaction center utility infrastructure 601 includes a database 620 for directory services (DS), a reporting database 630 (RD) and a backup/restore (B/R) database 632. Additionally, the right half of the development and testing environment includes a duplicate of a subset of the computer systems in the production environment and, thus, are numbered the same as the left hand side of the development and testing environment. Some systems, such as, the agent desktop 610 and the directory services database 620 are not duplicated within the development and testing environment, however, the remainder of the systems are identical to that included in the production environment. Moreover, the development and testing environment further includes an additional computer system 629 for application development tools (abbreviated Tools). As such, modifications to the production environment can be developed and tested within the development and testing environment before being deployed in the actual production environment, thus, avoiding any errors in the production environment that could lead to the on-demand customer interaction center utility infrastructure 600 becoming unavailable.

Accordingly, any of the embodiments of the present invention as shown in FIGS. 2 through 6 can be deployed, managed, serviced by a service provider or hosting company that offers an on-demand customer interaction center utility infrastructure serving multiple customers. Preferably, the invention provides a business method that performs the process steps of the invention on a subscription, advertising and/or fee basis. In particular, a service provider or hosting company, such as a solution integrator could offer to implement an on-demand customer interaction center utility infrastructure for a customer in a shared environment. In this case, the service provider can, for instance, create, maintain, and support a computer infrastructure that performs the process steps of the invention for one or more customers. In return, the service provider can receive payment from the customer or customers under a subscription and/or fee agreement and/or the service provider can receive payment from the sale or advertising of content to one or more third parties.

As one can appreciate, each of the different systems (IVR, call routing, etc.) in the on-demand customer interaction center (ODCIC) utility infrastructure, for instance, as shown in FIG. 5 can be any system of the numerous systems that are commercially available in the marketplace that is suited for the respective task/function and where a service provider has negotiated competitive prices with the system vendor, such that the service provider can offer to a plurality of customers the on-demand customer interaction center utility infrastructure in a cost efficient manner.

The foregoing descriptions of specific embodiments of the present invention have been presented for the purpose of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for implementing an on-demand customer interaction center utility infrastructure serving a plurality of customers in a shared environment, said method comprising the steps of:
providing an on-demand customer interaction center utility infrastructure serving a plurality of customers, said on-demand customer interaction center utility infrastructure comprising a plurality of components;
configuring a solution for at least one customer of said plurality of customers, said solution comprising sharing one or more components of said plurality of components of said on-demand customer interaction center utility infrastructure; and
establishing metrics to be monitored and achieved for said at least one customer for calculating a customer utilization fee, such that said at least one customer pays for said one or more components utilized in said on-demand customer interaction center utility infrastructure based on achievement of said metrics.

2. The method according to claim 1, wherein said providing step further comprises the step of:
negotiating competitive prices with a plurality of vendors for each of said plurality of components of said on-demand customer interaction center utility infrastructure.

3. The method according to claim 2, wherein said providing step further comprises the steps of:
providing a production environment comprising a separate location for ensuring business continuity of said at least one customer; and
providing a development and testing environment for developing and testing a modification to said plurality of components of said on-demand customer interaction center utility infrastructure before deployment in said production environment.

4. The method according to claim 3, wherein said one or more components comprises at least one of: infrastructure component, processes and applications component, contact center operations and management component, reporting component, and human resources component.

5. The method according to claim 4, wherein said infrastructure component comprises at least one of: computer resources, network resources, security resources and software resources.

6. The method according to claim 5, wherein said contact center operations and management component comprises at least one of work force management, quality assurance monitoring and knowledge database.

7. The method according to claim 6, wherein said reporting component comprises at least one of: usage metrics and utilization, agent performance, and end-to-end customer interaction.

8. The method according to claim 7, wherein said human resources component comprises at least one of: development personnel, maintenance personnel, support personnel, vendor management personnel and project management personnel.

9. A system for hosting an on-demand customer interaction center utility infrastructure, comprising:
a network communications channel;
one or more call centers connected via said network communications channel;
an on-demand customer interaction center utility infrastructure coupled to said one or more call centers via said network communications channel, said on-demand customer interaction center utility infrastructure comprising a plurality of components configured to serve a plurality of customers, including a component for tracking usage metrics to be achieved for one or more components selected to be shared and utilized by each customer of said plurality of customers, wherein said one or more components selected is configured to provide a comprehensive solution for service delivery to end users of said each customer of said plurality of customers, such that an end user of any customer of said plurality of customers can access said service delivery provided by said on-demand customer interaction center utility infrastructure on behalf of said any customer using any one of multiple channels supported by said network communications channel, and such that said each customer pays for said one or more components utilized based on said usage metrics tracked and achieved; and wherein said on-demand customer interaction center utility infrastructure provides a production environment comprising a separate location for ensuring business continuity of said each customer and provides a development and testing environment for developing and testing a modification to said plurality of components of said on-demand customer interaction center utility infrastructure before deployment in said production environment.

10. The system according to claim 9, wherein said one or more components comprises at least one of: infrastructure component, processes and applications component, contact center operations and management component, reporting component, and human resources component.

11. The system according to claim 10, wherein said infrastructure component comprises at least one of: computer resources, network resources, security resources and software resources.

12. The system according to claim 11, wherein said contact center operations and management component comprises at least one of work force management, quality assurance monitoring and knowledge database.

13. The system according to claim 12, wherein said reporting component comprises at least one of: usage metrics and utilization, agent performance, and end-to-end customer interaction.

14. The system according to claim 13, wherein said human resources component comprises at least one of: development personnel, maintenance personnel, support personnel, vendor management personnel and project management personnel.

15. A computer program product for implementing an on-demand customer interaction center utility infrastructure serving a plurality of customers in a shared environment, said computer program product comprising:
a computer readable medium;
first program instructions to establish an on-demand customer interaction center utility infrastructure for delivering services to end users of a plurality of customers, said on-demand customer interaction center utility infrastructure comprising a plurality of components;
second program instructions to customize a comprehensive solution for at least one customer of said plurality of customers involving configuring one or more components selected from said on-demand customer interaction center utility infrastructure to be shared and utilized by said at least one customer with said plurality of customers;
third program instructions to determine metrics to be measured and achieved for said at least one customer for calculating a customer utilization fee based on said one or more components shared and utilized by said at least one customer and based on achievement of said metrics measured for said at least one customer; and wherein said first, second and third program instructions are stored on said computer readable medium.

16. The computer program product according to claim 15, wherein said first program instructions include instructions to provide a production environment comprising a separate location for ensuring business continuity of said at least one customer of said plurality of customers and to provide a development and testing environment for developing and testing a modification to said plurality of components of said on-demand customer interaction center utility infrastructure before deployment in said production environment.

17. The computer program product according to claim 16, wherein said one or more components comprises at least one of: infrastructure component, processes and applications component, contact center operations and management component, reporting component, and human resources component.

18. The computer program product according to claim 17, wherein said infrastructure component comprises at least one of: computer resources, network resources, security resources and software resources.

19. The computer program product according to claim 18, wherein said contact center operations and management component comprises at least one of work force management, quality assurance monitoring and knowledge database.

20. The computer program product according to claim 19, wherein said reporting component comprises at least one of: usage metrics and utilization, agent performance, and end-to-end customer interaction; and wherein said human resources component comprises at least one of: development personnel, maintenance personnel, support personnel, vendor management personnel and project management personnel.

21. A process for deploying computing infrastructure comprising integrating computer-readable code into a computing system, wherein said code in combination with said computing system is capable of performing a process for hosting an on-demand customer interaction center utility infrastructure, said process comprising:
providing an on-demand customer interaction center utility infrastructure serving a plurality of customers, said on-demand customer interaction center utility infrastructure comprising a plurality of components;
configuring a solution for a customer of said plurality of customers, said solution comprising sharing one or more components of said plurality of components of said on-demand customer interaction center utility infrastructure; and
establishing metrics to be monitored and achieved for said customer for calculating a customer utilization fee, such that said customer pays for said one or more components utilized in said on-demand customer interaction center utility infrastructure based on achievement of said metrics.

22. The process according to claim 21, wherein said providing step further comprises the step of:
negotiating competitive prices with a plurality of vendors for each of said plurality of components of said on-demand customer interaction center utility infrastructure.

23. The process according to claim 22, wherein said providing step further comprises the steps of:
providing a production environment comprising a separate location for ensuring business continuity of said customer; and
providing a development and testing environment for developing and testing a modification to said plurality of components of said on-demand customer interaction center utility infrastructure before deployment in said production environment.

24. The process according to claim 23, wherein said one or more components comprises at least one of: infrastructure component, processes and applications component, contact center operations and management component, reporting component, and human resources component.

25. The process according to claim 24, wherein said infrastructure component comprises at least one of: computer resources, network resources, security resources and software resources; wherein said contact center operations and management component comprises at least one of work force management, quality assurance monitoring and knowledge database; wherein said reporting component comprises at least one of: usage metrics and utilization, agent performance, and end-to-end customer interaction; and wherein said human resources component comprises at least one of: development personnel, maintenance personnel, support personnel, vendor management personnel and project management personnel.
